(19) United States
(12) Patent Application Publication
(10) Pub. No.: US 2005/0129875 A1
(43) Pub. Date: Jun. 16, 2005

(54) Aligned liquid crystal layer containing onium salts and process for increasing the tilt

(75) Inventors: Deepak Shukla, Webster, NY (US); Thomas R. Welter, Webster, NY (US); James F. Elman, Fairport, NY (US); Samir Y. Farid, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/736,342

(22) Filed: Dec. 15, 2003

(51) Int. Cl. C09K 19/00

(52) U.S. Cl. 428/1.2

(57) ABSTRACT

Disclosed is a multilayer film comprising a substrate bearing an aligned liquid crystal layer wherein the liquid crystal layer contains an onium salt represented by formula (I):
(R)_{b}M⁺X⁻ I wherein: each R is an independently selected straight, branched or cyclic alkyl group or an aromatic group and b is 2, 3, or 4;
M+ is a cation chosen from periodic group Va, VIa, and VIIa of the Periodic Table of Elements; and X⁻ is a counter-ion; provided the salt may be present as an oligomeric or polymeric form of the salt.

### FIELD OF THE INVENTION

This invention relates to a method for controlled increase of tilt angle of liquid crystal molecules by onium salts and to an aligned layer of liquid crystal molecules on a substrate having an orientation layer and a liquid crystal layer containing onium salt effective to increase the tilt angle of liquid crystal molecules.

### BACKGROUND OF THE INVENTION

The vast majority of liquid crystal displays (LCD) require uniform liquid crystal (LC) molecular orientation, usually with a small angle between the LC director n and substrate; this angle is called the “pretilt” angle. A number of methods have been used to achieve tilted alignment of LCs. These are described in detail in Fundamentals and Applications of Liquid Crystals, published by Industrial Survey Association (1991). The most common technique to achieve oblique alignment involves deposition of a thin polymer layer on the substrate, which is subsequently rubbed. Rubbing of the polymer determines the azimuthal orientation of the LC molecular alignment, and induces a non-zero pretilt angle. Polyimide (PI) films are commonly used for rubbing alignment of LC's because of their outstanding thermal stability, low dielectric constant, excellent chemical resistance and high productivity. Furthermore, LC alignment on rubbed PI film generally provides a stable pretilt angle preventing reverse tilt disclination of LC molecules with applied voltage. However, the pretilt angle depends on the properties of the orientation film itself. Thus to satisfy specific pretilt angle requirements for various LCD modes, specific polyimides have been made for controlling the pretilt angle. For example, polyimides with long alkyl and fluorinated alkyl side groups have been used to generate high LC pretilt angles. It has been suggested that steric interaction between LC molecules and branched long alkyl side chains is a possible cause for high pretilt angles.

The rubbing method suffers from several drawbacks, however, especially accumulation of static charges at the thin film transistor sites and generation of dust particles. Recently, new non-rubbing alignment techniques, based on photo-induced anisotropy of the polymerizable orienting layers, have been introduced. Typically the photosensitive polymer films are illuminated by polarized ultraviolet light, and the azimuthal orientation of the resulting planar alignment depends on the specifics of the photo-induced reaction. In contrast to the rubbing technique, neither excess charge nor dust is created on the substrates, yet control is maintained over both the tilt angle and the anchoring strength. The traditional rubbing technique establishes a unique direction of the tilted easy axis; this direction is determined by the direction of rubbing. On the other hand, for photoalignment there is a twofold degeneracy of the light-induced easy axis. This twofold degeneracy causes poor reproducibility of the pretilt angle and, more importantly, the appearance of defects at the resulting boundaries between orientation domains. This degeneracy may be partially removed during the filling of the LC cell because of the effect of flow alignment, but the resulting alignment is not temporally stable. To date, the most promising method to break this degeneracy involves oblique irradiation of the photoalignment layer. Oblique polarized irradiation makes an angle with the surface and the photoreaction for on-axis transition moments is much easier than that of off-axis ones. Consequently the tilt degeneracy is broken and the liquid crystals tilt in a preferred direction. Such an irradiation scheme requires specialized equipment and have proven difficult to implement in a large scale process.

Other non-contact for aligning LC molecules include a stretched polymer, a Langmuir Blodgett film, a grating structure produced by microlithography, oblique angle deposition of silicon oxide, and ion beam irradiation of a polyimide surface as in U.S. Pat. No. 5,770,826. The method places the LC's on a polyimide surface which has been bombarded with low energy (about 100 eV) Ar+ ions. This method has been extended to include diamond-like carbon (DLC), amorphous hydrogenated silicon, SiC, SiO₂, glass, Si₃N₄, Al₂O₃, CeO₂, SnO₂, and ZnTiO₂ films as described in U.S. Pat. No. 6,020,946.

JP 2002038158 discloses a method for the formation of a liquid crystal layer containing liquid crystal molecules on a substrate and the orientation of the liquid crystal molecules. A pyridinium quaternary salt is added to the liquid crystal layer or a layer adjacent to it, and the inclination angle of the liquid crystal molecules is controlled by the action of the pyridinium quaternary salt. Although this invention provides an advantage in controlling the tilt angle of liquid crystal over other existing methods, it only provides a limited class of molecules that are capable of increasing the tilt; thus, further new materials for inducing LC pretilt are needed.

In all the methods of LC alignment described above, control of LC pretilt angle requires the use of a specific combination of the LC molecules and the alignment polymer or specific materials. Developing and optimizing such combination (of alignment polymers and LC's) is a difficult and time-consuming process. There is a need for alternative ways to control the pretilt angle of liquid crystal to the desired angle and in an easy manner.

### SUMMARY OF THE INVENTION

The invention provides a multilayer film comprising a substrate bearing an aligned liquid crystal layer wherein the liquid crystal layer contains an onium salt represented by formula (I):
(R)_{b}M⁺X⁻ I
wherein:
each R is an independently selected straight, branched or cyclic alkyl group or an aromatic group and b is 2, 3, or 4;
M⁺ is a cation chosen from periodic group Va, VIa, and VIIa of the Periodic Table of Elements; and X⁻ is a counter-ion;
   provided the salt may be present as an oligomeric or polymeric form of the salt.

### BRIEF DESCRIPTION OF THE DRAWING

FIG. 1 is a cross-sectional schematic of a multilayer of the invention.

### DETAILED DESCRIPTION OF THE INVENTION

All reference to the Periodic Table of the Elements herein shall refer to the Periodic Table of the Elements, published and copyrighted by CRC Press, Inc., 1995. Also, any reference to a Group or Groups shall be to the Group or Groups as reflected in this Periodic Table of the Elements using the IUPAC system for numbering groups.

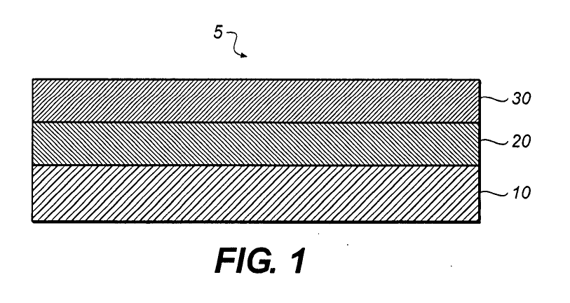

The present invention provides a method for controlled tilt increase of oriented liquid crystal molecules by added onium salts as summarized above. The current invention is described by referring to FIG. 1 which shows a cross-sectional schematic view of an oriented liquid crystal multilayer film 5. This structure comprises a substrate 10 of transparent material, such as glass or polymer. It should be understood that to be called as a substrate, a layer must be solid and mechanically strong so that it can stand alone and support other layers. A typical substrate is made of triacetate cellulose (TAC), polyester, polycarbonate, polysulfone, polyethersulfone, or other transparent polymers, and has a thickness of 25 to 500 micrometers. Substrate 10 typically has low in-plane retardation, preferably less than 10 nm, and more preferably less than 5 nm. In some other cases, the substrate 10 may have larger in-plane retardation (some short discussion of the relevance of retardation might be useful here or in the introduction) between 15 to 150 nm. Typically, when the substrate 10 is made of triacetyl cellulose, it has out-of-plane retardation around −40 nm to −120 nm. This is a desired property when the compensator is designed to compensate a liquid crystal state with an ON voltage applied. The in-plane retardation discussed above is defined as the absolute value of (nₓ−n_{y})d and the out-of-plane retardation discussed above is defined as [(nₓ+n_{y}/2)−n_{z}]d, respectively. The refractive indices nₓ and n_{y} are along the slow and fast axes in plane of the substrate 10, respectively, n_{z} is the refractive index along the substrate thickness direction (Z-axis), and d is the substrate 10 thickness. The substrate is preferably in the form of a continuous (rolled) film or web. Glass plates, ITO substrates, color filter substrates, quartz plates, silicon wafers, can also be used as substrates.

The substrate 10 can be used alone or as a pair. In the case of usage as a pair, if necessary, a spacer, a sealing agent or the like can also be used. In this invention, it is preferable that the layer adjacent to the liquid crystal layer is the layer nearest the liquid crystal layer 30 among the layers located between the substrate and the liquid crystal layer 30. It is also acceptable that the layer adjacent to the liquid crystal layer 30 functions as an orientation film or a transparent electrode.

On the substrate 10, an orientation layer 20 is applied, and a liquid crystal layer 30 is disposed on top of layer 20. The orientation layer 20 can be oriented by various techniques. In one example, the orientation layer contains a rubbing-orientable material such as a polyimide or polyvinyl alcohol and can be oriented by a rubbing technique. In another example, the orientation layer 20 contains a shear-orientable material and can be oriented by a shear-alignment technique. In another example, the orientation layer 20 contains an electrically- or magnetically-orientable material and can be oriented by an electrical- or magnetic-alignment technique. In another example, the orientation layer can also be a layer of SiOx fabricated by oblique deposition. In another example, the orientation layer 20 contains a photo-orientable material and can be oriented by a photo-alignment technique. Photo-orientable materials include, for example, photo isomerization polymers, photo-dimerization polymers, and photo-decomposition polymers. In a preferred embodiment, the photo-orientable materials are cinnamic acid derivatives as disclosed in U.S. Pat. No. 6,160,597. Such materials may be oriented and simultaneously cross-linked by selective irradiation with linear polarized UV light.

Mainly liquid crystal molecules constitute the liquid crystal layer 30. As the liquid crystal molecules, discotic liquid crystal molecules, rod-shaped (nematic) liquid crystal molecules, and cholesteric liquid crystal molecules can be used. Nematic liquid crystal molecules are especially preferred. Two or more types of liquid crystal molecules can also be used in combination. Components (such as a colorant, a dopant for tilt angle increase, dichroic colorant, polymer, polymerizing agent, sensitizing agent, phase transition temperature depressant, and stabilizer) can also be added to the liquid crystal layer in addition to the liquid crystal molecules. A variety of well established methods can be used to apply the liquid crystal layer 30 to the substrate. Accordingly, liquid crystal layer 30 can be coated on the orientation layer 20 using, the curtain coating method, extrusion coating method, roll coating method, spin coating method, dip coating method, bar coating method, spray coating method, printing coating method, and the like.

In one embodiment of the invention, the liquid crystal layer 30 is typically a nematic liquid crystalline pre-polymer when it is first disposed on the orientation layer 20, and is cross-linked by a further UV irradiation, or by other means such as heat. In a preferred embodiment, the anisotropic layer contains a material such as a diacrylate or diepoxide with positive birefringence as disclosed in U.S. Pat. No. 6,160,597 (Schadt et al.) and U.S. Pat. No. 5,602,661 (Schadt et al.). The optic axis in the anisotropic layer 30 is usually tilted relative to the layer plane, and varies across the thickness direction. The anisotropic layer 30 in accordance with the present invention is applied from a liquid medium containing a onium salt or a mixture of onium salts.

The onium salt increases the tilt angle of the liquid crystal molecules in layer 30 without detrimentally affecting its adhesion to orientation layer 20.

In the present invention, onium salt is used for controlled increase of liquid crystal molecules tilt angle. In the scope of the invention, the onium salts are periodic group Va, VIa, and VIIa cations represented by general formula I below.
(R)_{b}M⁺X⁻ I
Wherein, R is a straight, branched or cyclic alkyl of 1 to 12 carbon atoms, an aryl of 6 to 12 carbon atoms, or an arylalkyl of 7 to 12 carbon atoms; cation M+ is a cation chosen from periodic group Va, VIa, and VIIa; X⁻ is a non-nucleophilic counter-ion; and the letter b is 2,3, or 4.

R is a represent aromatic groups and generally have from 4 to 20 carbon atoms, may be selected from aromatic hydrocarbon rings, e.g. phenyl or naphthyl and hetero-aromatic groups including thienyl, furanyl and pyrazolyl, and may be substituted with alkyl groups, e.g. methyl, alkoxy groups, e.g. methoxy, chlorine, bromine, iodine, fluorine, carboxy, cyano or nitro groups, or any combinations thereof. Condensed aromatic-heteroaromatic groups, e.g. 3-indolinyl, may also be present.

When reference in this application is made to a particular group, unless otherwise specifically stated, the group may itself be unsubstituted or substituted with one or more substituents (up to the maximum possible number). For example, “alkyl” group refers to a substituted or unsubstituted alkyl group, such as arylalkyl group or sulfoalkyl group while “aryl” group refers to a substituted or unsubstituted aryl group (with up to six substituents) such as alkaryl or sulfoaryl group. The substituent may be itself substituted or unsubstituted. Examples of substituents on any of the mentioned groups can include known substituents, such as: chloro, fluoro, bromo, iodo; hydroxy; alkoxy, particularly those “lower alkyl” (that is, with 1 to 12 carbon atoms, for example, methoxy, ethoxy; substituted or unsubstituted alkyl, particularly lower alkyl (for example, methyl, trifluoromethyl); thioalkyl (for example, methylthio or ethylthio), particularly either of those with 1 to 12 carbon atoms; substituted or unsubstituted alkenyl, preferably of 2 to 12 carbon atoms (for example, ethenyl, propenyl, or butenyl); substituted and unsubstituted aryl, particularly those having from 6 to 20 carbon atoms (for example, phenyl); and substituted or unsubstituted heteroaryl, particularly those having a 5 or 6-membered ring containing 1 to 3 heteroatoms selected from N, O, or S (for example, pyridyl, thienyl, furyl, pyrrolyl); acid or acid salt groups; such groups as hydroxyl, amino, alkylamino, cyano, nitro, carboxy, carboxylate, acyl, alkoxycarbonyl, aminocarbonyl, sulfonamido, sulfamoyl, sulfo, sulfonate, or alkylammonium; and other groups known in the art. Alkyl substituents may specifically include “lower alkyl” (that is, having 1-12 carbon atoms), for example, methyl, ethyl, and the like. Further, with regard to any alkyl group or alkylene group, it will be understood that these can be branched or unbranched and include ring structures.

In a useful embodiment, the onium salts in the present invention are represented by formula (II):
(R)₂M⁺X⁻ II
wherein, R and X are as difined for formula (I) and M⁺ is a halonium cation chosen from periodic group VIIa. Illustrative examples of the periodic group VIIa onium salts are shown below, but the invention is not limited to thereto.

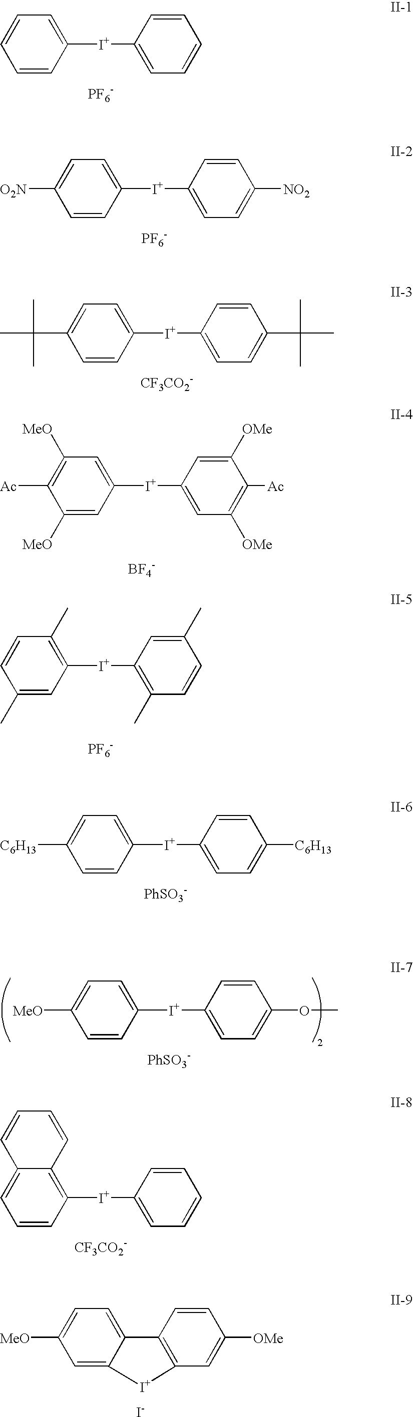

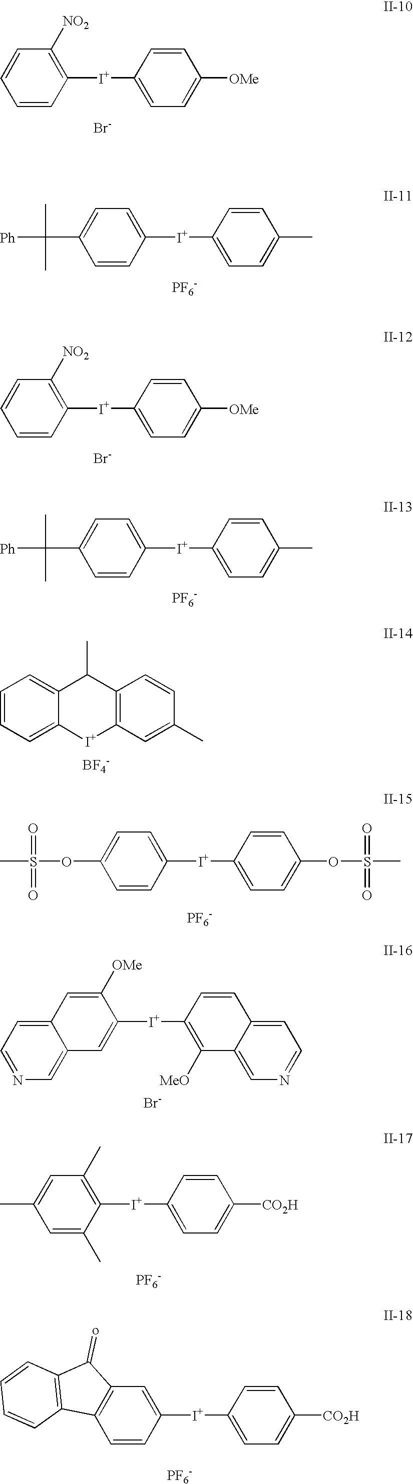

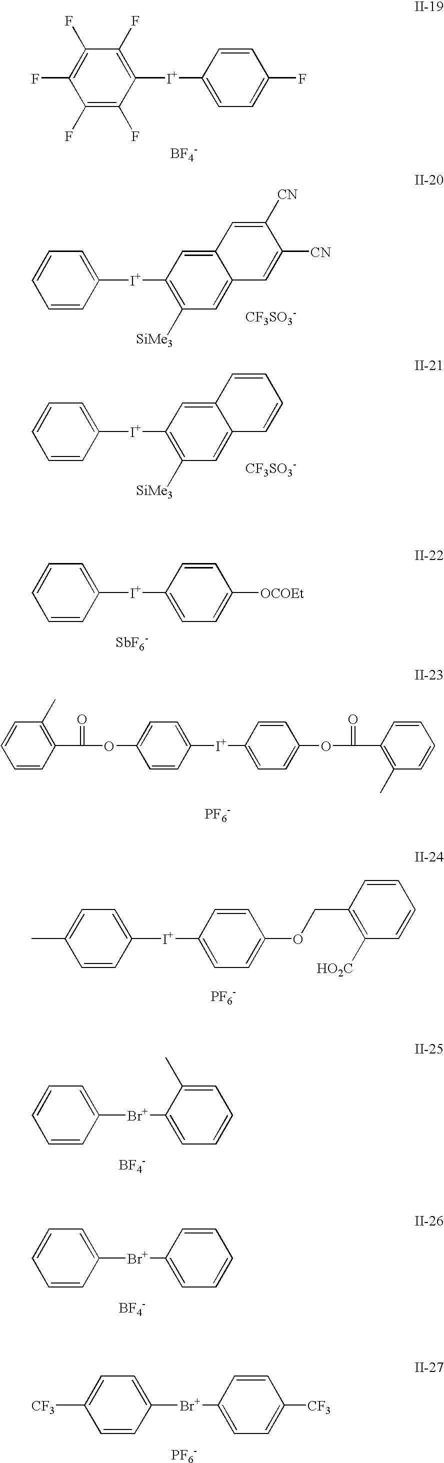

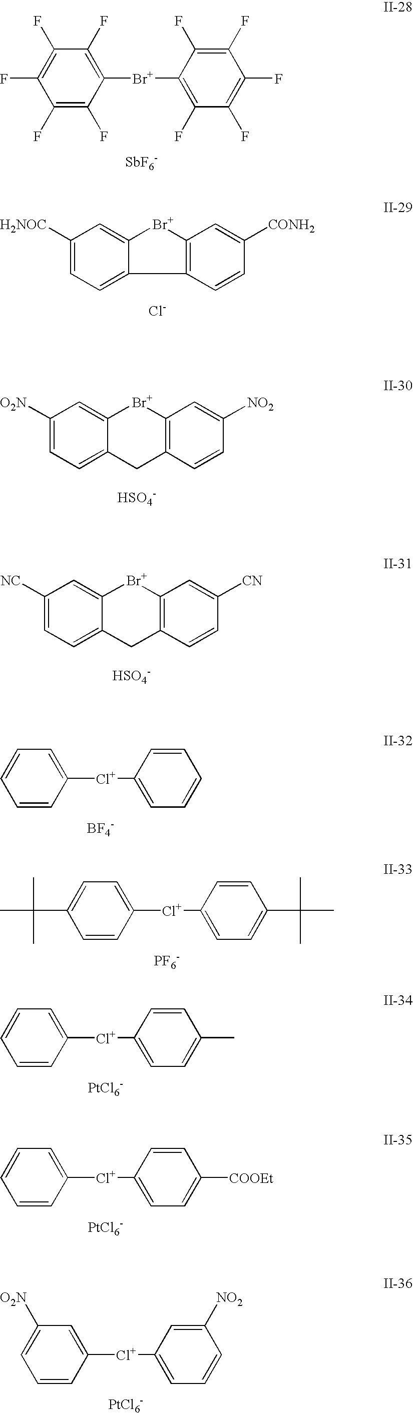

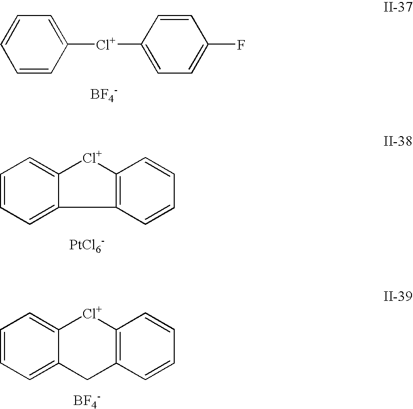

In a further useful embodiment, the onium salts in the present invention are represented by formula (III):
(R)₃M⁺X⁻ III
wherein, R and X are as described for formula (I) and M+ is a cation chosen from periodic group VIa. Illustrative examples of the periodic group VIa onium salts are shown below, but the invention is not limited to thereto.

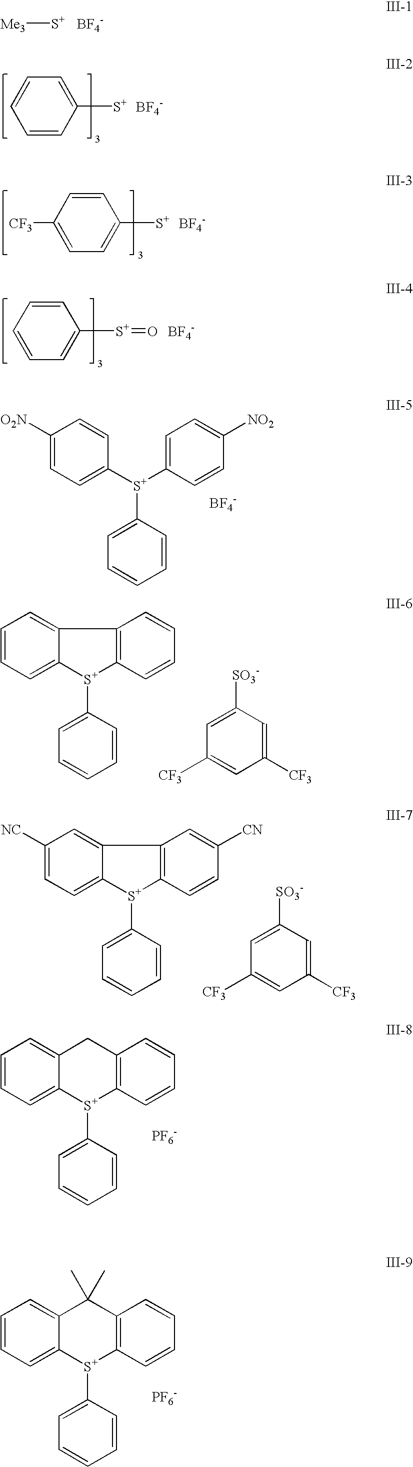

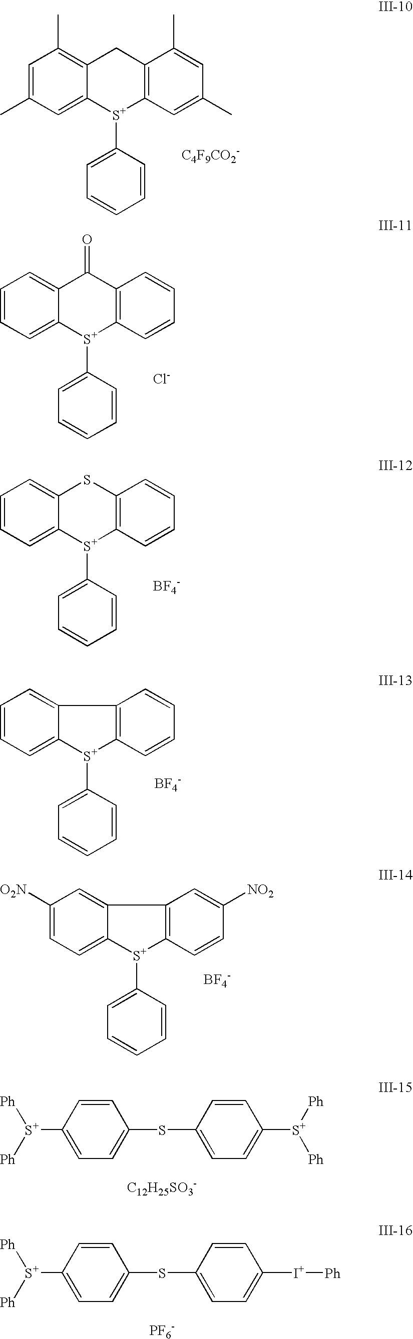

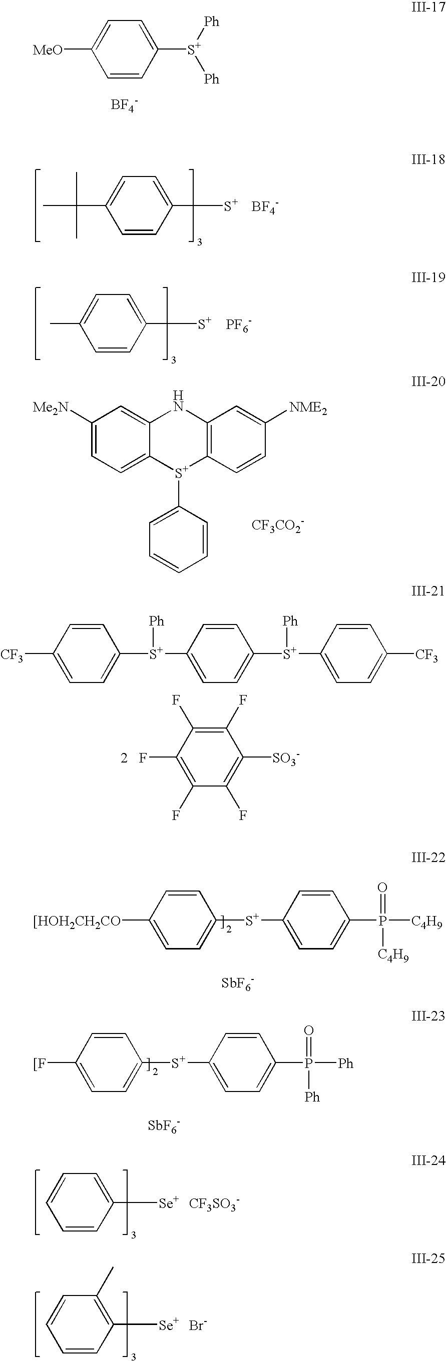

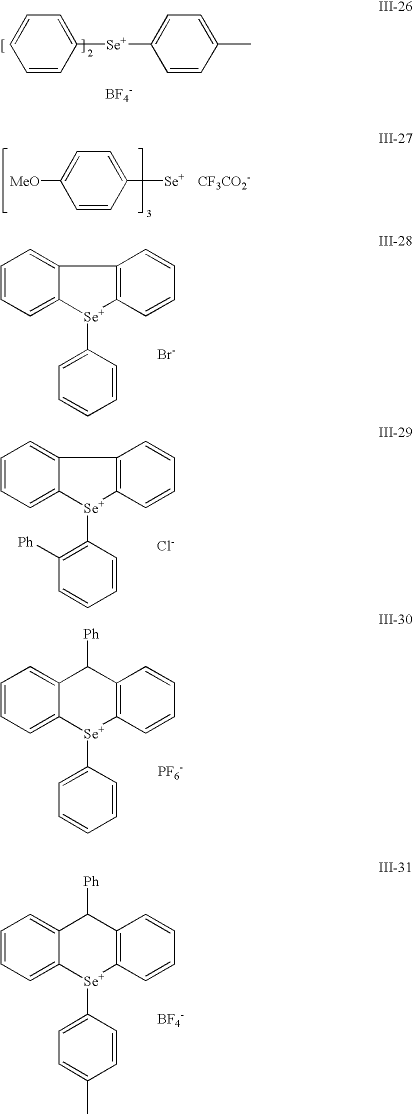

In a useful embodiment, the onium salts in the present invention are represented by formula (IV):
(R)₄M⁺X⁻ IV
wherein, R and X are as defined for formula (I) and M+ is a cation chosen from periodic group Va.

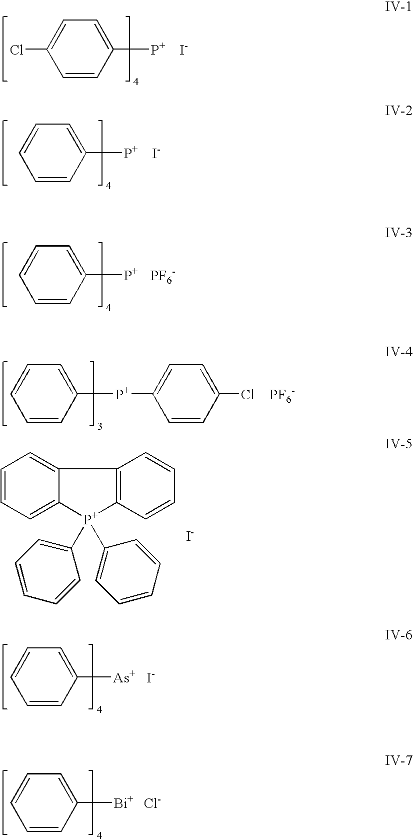

Other suitable onium salts include those contained as part of a polymeric structure linked by the R groups of the salt.

In general onium salts are soluble in the coating solvent and addition of these salts to liquid crystal layer 30 does not change the refractive index of the liquid crystal layer 30 by more than about +10 percent. More preferably such onium salts will not change the refractive index of the liquid crystal layer 30 by more than ±5 percent. Most preferably such refractive index will not change the refractive index of the liquid crystal layer 30 by more than ±2 percent. In addition, such onium salts are desirably capable of increasing the average tilt of the liquid crystal layer 30 by more than 30%. More preferably such onium salts will increase the average tilt of the liquid crystal layer 30 by more than 50%. Most preferably such onium salts are capable of increasing the average tilt of the liquid crystal layer 30 by more than about 95%.

The onium salt can be added into a coating solution of liquid crystal layer 30. The onium salt is added in an amount appropriate to attain the desired tilt angle increase of the liquid crystal molecules without disturbing the orientation of the liquid crystal layer 30. Typically, the onium salt is added up to 10 wt % of the anisotropic layer 30. Usually, up to 5 wt % of the anisotropic layer and normally less than 2 wt % of the anisotropic layer is sufficient. The amount of the onium salt added is dependent on both the composition of the liquid crystal layer 30 and the tilt increase desired since both of these can impact the target.

The anisotropic layer may also contain addenda such as surfactants, light stabilizers and UV initiators. UV initiatiors include materials such as benzophenone and acetophenone and their derivatives; benzoin, benzoin ethers, benzil, benzil ketals, fluorenone, xanthanone, alpha and beta naphthyl carbonyl compounds and ketones. Preferred initiators are alpha-hydroxyketones.

The present invention is illustrated in more detail by the following non-limiting examples.

In examples described below in-plane retardation was measured to assess the quality of liquid crystal alignment. For samples with tilt angles near zero, the measured (effective) birefringence of the LC layer should be between 0.12-0.13. However, as tilt angle increases, the effective birefringence decreases. For a series of examples of approximately the same layer thickness, this should result in decreasing in plane retardation with increasing tilt angle. This is exactly what is seen for these examples, confirming good alignment for all examples.

### EXAMPLE 1—COMPARISON

This example demonstrates the photo-alignment of liquid crystal molecules on a photo-aligned layer on a glass substrate.

On a clean glass plate, a coating solution containing a mixture of VANTICO Staralign™ 2110 and Staralign™ 2100 photo-aligning vinyl cinnamate polymers (in 30:70 wt % ratio; 1 wt % total solids in methyl ethyl ketone) was spun cast (@ 700-1000 rpm). The sample was dried at 55° C. for 5 min. and then exposed to 308 nm polarized light (15-30 mJ/cm²) at an inclination of 20 degrees away from normal angle of incidence to obtain a photo-aligned orientation layer. Typically this produced a 30-100 nm thick layer as measured by ellipsometry.

On the orientation layer a solution of liquid crystal prepolymer (LCP, CB483MEK from Vantico Co, 7 wt % in methyl ethyl ketone, supplied with photoinitiator) in methyl ethyl ketone was spun cast @ 700-1000 rpm. The sample was then heated at a temperature of 55° C. for 3 minutes to orient the nematic liquid crystalline layer and remove solvent. The sample was cooled to room temperature and the anisotropic layer was fixed by exposing to 365 nm light (300-1000 mJ/cm²) under an atmosphere of nitrogen. In-plane retardation measurement indicated that liquid crystal molecules were aligned parallel to the direction of polarized irradiation. In-plane retardation, average tilt angle, and thickness of the anisotropic layer were measured by ellipsometry (J. A. Woollam Co., Model M2000V). The measured average tilt angle method had accuracy of±2.0 degrees.

### EXAMPLE 2—INVENTIVE

This example shows that addition of di(4-tert-butylphenyl)iodonium trifluoroacetate (1-3) salt to liquid crystal layer comprising of two liquid crystal molecules increases the average tilt angle.

A photo-aligned orientation layer was prepared as in Example 1. Di(4-tert-butylphenyl)iodonium trifluoroacetate (I-3) (0.25-1.5 wt % of dried liquid crystal layer) was added to LCP mixture CB483MEK (7 wt % solution with photoinitiator obtained from Vantico Co.) and spun cast on the orientation layer (@ 700-1000 rpm). The sample was then heated at a temperature of 55° C. for 3 minutes to orient the nematic liquid crystalline layer and remove solvent. The sample was cooled to room temperature and liquid crystal layer cross-linked by exposing to 365 nm light (300-1000 mJ/cm²) under an atmosphere of nitrogen.

TABLE I

| | | | In Plane | Average |
|---|---|---|---|---|
| | Wt % of | Layer | Retardation | Tilt |
| | added | Thickness, | nm(measured @ | Angle |
| | I-3 | (nm) | 550 nm) | (±2°) |
| Comparison | 0 wt % | 616 | 64 | 12 |
| Example. 1 | | | | |
| Inventive | 0.25 wt % | 592 | 48 | 15 |
| Example. 2 | 0.50 wt % | 552 | 48 | 27 |
| | 2.0 wt % | 594 | 47 | 33 |

The aforementioned examples in Table I clearly demonstrate that compared to comparison Example 1 addition of I-3 to liquid crystal layer in Inventive Example 2 increases the average tilt angle of liquid crystal molecules.

### EXAMPLE 3—INVENTIVE

This example shows that addition of diphenyliodonium hexafluorophosphate (II-1) salt to liquid crystal layer increases the average tilt angle.

A photo-aligned orientation layer was prepared as in Example 1. Diphenyliodonium hexafluorophosphate (II-1) (0.25-1.5 wt % of dried liquid crystal layer) was added to LCP mixture CB483MEK (7 wt % solution with photoinitiator obtained from Vantico Co.) and spun cast on the orientation layer (@ 700-1000 rpm). The sample was then heated at a temperature of 55° C. for 3 minutes to orient the nematic liquid crystalline layer and remove solvent. The sample was cooled to room temperature and liquid crystal layer was cross-linked by exposure to 365 nm light (300-1000 mJ/cm²) under an atmosphere of nitrogen.

TABLE II

| | | | In Plane | |
|---|---|---|---|---|
| | Wt % of | Layer | Retardation | |
| | added | Thickness, | nm(measured | Average Tilt |
| | II-1 | (nm) | @ 550 nm) | Angle (±2°) |
| Comparison | 0 wt % | 616 | 64 | 12 |
| Example. 1 | | | | |
| Inventive | 0.50 wt % | 549 | 46 | 25 |
| Example. 3 | 1.00 wt % | 594 | 43 | 33 |

The aforementioned examples in Table II demonstrate that compared to comparison Example 1 addition of diphenyliodonium hexafluorophosphate (II-1) in Inventive Example 3 increases the average tilt angle of liquid crystal molecules.

### EXAMPLE 4—COMPARISON

This example demonstrates the photo-alignment of a single liquid crystal molecule on a glass substrate.

Liquid crystals were prepared following the general procedure described in W02000048985(A1). A solution of a mixture of liquid crystals was made following the general procedure disclosed in W02000048985(A1). Thus, a 7% by weight mixture of liquid crystals was made by mixing LC-1 in methyl ethyl ketone. IRGACURE 369 (2-Benzyl 2-dimethylamino 1-(4-morpholinophenyl) butanone-1) from Ciba-Giegy (1% by weight of LCs), TINUVIN-123 (bis (1-octyloxy-2,2,6,-tetramethyl-4-piperidyl) sebacate) (1% by weight of LCs), and 2,6-di-tert-butyl-p-cresol (2% by weight of LCs) were added to the LC solution.

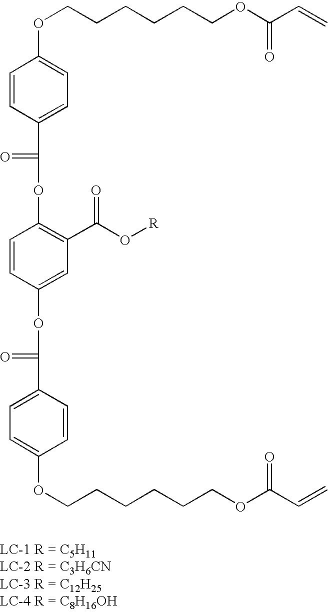

A photo-aligned orientation layer was prepared as in Example 1. On the orientation layer a solution of LC- 1 prepared above in methyl ethyl ketone was spun cast @ 700-1000 rpm. The sample was then heated at a temperature of 55° C. for 3 minutes to orient the nematic liquid crystalline layer and remove solvent. The sample was cooled to room temperature and the anisotropic layer was fixed by exposing to 365 nm light (300-1000 mJ/cm²) under an atmosphere of nitrogen. In-plane retardation measurement indicated that liquid crystal molecules were aligned parallel to the direction of polarized irradiation. In-plane retardation, average tilt angle, and thickness of the anisotropic layer were measured by ellipsometry (J. A. Woollam Co., Model M2000V). The measured average tilt angle method had accuracy of ±2.0 degrees.

### EXAMPLE 5—INVENTIVE

This example shows addition of I-3 salt to liquid crystal layer comprising of one liquid crystal molecule (LC-1) increases the average tilt angle.

A photo-aligned orientation layer was prepared as in Example 1. Di(4-tert-butylphenyl)iodonium hexafluorophosphate (II-33) (0.25-1.5 wt % of dried liquid crystal layer) was added to the methyl ethyl ketone solution of crosslinkable diacrylate nematic liquid crystal solution (prepared above) and spun cast on the orientation layer (@ 700-1000 rpm). The sample was then heated at a temperature of 55° C. for 3 minutes to orient the nematic liquid crystalline layer and remove solvent. The sample was cooled to room temperature and liquid crystal layer was cross-linked by exposing to 365 nm light (300-1000 mJ/cm 2) under an atmosphere of nitrogen.

TABLE III

| | | | In Plane | |
|---|---|---|---|---|
| | | Layer | Retardation | |
| | Wt % of added | Thickness, | nm(measured | Average Tilt |
| | II-33 | (nm) | @ 550 nm) | Angle (±2°) |
| Comparison | 0 wt % | 449 | 53 | 8 |
| Example. 4 | | | | |
| Inventive | 0.50 wt % | 473 | 51 | 17 |
| Example. 5 | | | | |

The aforementioned examples in Table III demonstrate that compared to comparison Example 4 addition of di(4-tert-butylphenyl)iodonium hexafluorophosphate (II-33) in Inventive Example 5 increases the average tilt angle of liquid crystal molecules.

### EXAMPLE 6—COMPARISON

This example demonstrates the alignment of a liquid crystal mixture comprising two liquid crystal molecules on a rubbed poly(vinylalcohol) (PVA) alignment layer.

An aqueous solution of poly(vinylalcohol) (PVA) (0.5% by weight) was spun cast (@ 700-1000 rpm) on a glass substrate. Sample was dried at 120° C. for 2 hours and then subjected to a rubbing treatment.

On the rubbed orientation layer a solution of liquid crystal prepolymer (LCP, CB483MEK from Vantico Co, 7 wt % in methyl ethyl ketone, supplied with photoinitiator) in methyl ethyl ketone was spun cast @ 700-1000 rpm. The sample was then heated at a temperature of 55° C. for 3 minutes to orient the nematic liquid crystalline layer and remove solvent. The sample was cooled to room temperature and the anisotropic layer was fixed by exposing to 365 nm light (300-1000 mJ/cm²) under an atmosphere of nitrogen. In-plane retardation measurement indicated that liquid crystal molecules were aligned parallel to the direction polarized irradiation.

### EXAMPLE 7—INVENTIVE

This example demonstrates addition of diphenyliodonium hexafluorophosphate salt (II-1) salt to liquid crystal layer increases its average tilt angle on a rubbed poly(vinylalcohol) (PVA) alignment layer.

A rubbed orientation was prepared as in Example 11. Diphenyliodonium hexafluorophosphate salt (II-1) salt (0.5 wt % of dried liquid crystal layer) was added to LCP mixture CB483MEK (7 wt % obtained from Vantico Co) and spun cast on the orientation layer (@ 700-1000 rpm). The sample was then heated at a temperature of 55° C. for 3 minutes to orient the nematic liquid crystalline layer and remove solvent. The sample was cooled to room temperature and liquid crystal layer cross-linked by exposing to 365 nm light (300-1000 mJ/cm²) under an atmosphere of nitrogen.

TABLE IV

| | | | In Plane | |
|---|---|---|---|---|
| | | Layer | Retardation | |
| | wt % of | Thickness, | nm(measured | Average Tilt |
| | Added II-1 | (nm) | @ 550 nm) | Angle (±2°) |
| Comparison | 0 wt % | 561 | 67 | 0.2 |
| Example. 6 | | | | |
| Inventive | 0.50 wt % | 554 | 61 | 15 |
| Example. 7 | | | | |

The aforementioned examples in Table IV clearly demonstrate that on a rubbed PVA orientation layer compared to Comparison Example 6 addition of diphenyliodonium hexafluorophosphate salt (II-1) to liquid crystal layer increases the average tilt angle of liquid crystal molecules.

An overall observation of the “In-Plane Retardation”, taking into consideration the layer thicknesses and variation in average tilt angles in the inventive vs. comparative examples, is that the in-plane retardation is not significantly affected by the altered tilt angle.

The patents and other publications referred to herein are incorporated herein in their entirety.

### Part List

5 Multilayer film
10 Substrate
20 Orientation layer
30 Liquid crystal layer

1. A multilayer film comprising a substrate bearing an aligned fixed liquid crystal layer wherein the fixed liquid crystal layer contains an onium salt represented by formula (I):
(R)_{b}M⁺X− I
wherein:
each R is an independently selected straight, branched or cyclic alkyl group or an aromatic group and b is 2, 3, or 4;
M⁺ is a cation chosen from periodic group VIa, and VIIa of the Periodic Table of Elements; and X⁻ is a counter-ion;
provided the salt may be present as an oligomeric or polymeric form of the salt.

2. The film of claim 1 wherein at least one R group is an alkyl group of 1-25 carbon atoms.

3. The film of claim 1 wherein at least one R group is an alkyl group of 1-6 carbon atoms.

4. The film of claim 1 wherein at least one R group is an aromatic group comprising a single or fused rings.

5. The film of claim 1 wherein at least one R group is an aryl group.

6. The film of claim 1 wherein at least one R group is a heteroaryl group.

7. The film of claim 1 wherein at least one R group is a phenyl group.

8. (canceled)

9. The film of claim 1 wherein M is a cation chosen from group VIIa.

10. The film of claim 1 wherein M is iodonium.

11. The film of claim 1 wherein X is a counterion whose conjugate acid has a pKa of less than 10.

12. The film of claim 1 wherein X is a counterion whose conjugate acid has a pKa of less than 5.

13. The film of claim 1 wherein X is selected from the group consisting of PF₆⁻, CF₃COO⁻, BF₄⁻, and C₆H12SO₃⁻.

14. The film of claim 1 wherein the M is a member of a 5- or 6-membered ring fused to one or more of the R groups.

15. The film of claim 1 wherein the salt is present in amount sufficient to improve the tilt without changing the refractive index of the layer by more than 10 percent.

16. The film of claim 1 wherein the amount of salt is sufficient to increase the tilt by at least 10% compared to the layer with no onium salt.

17. The film of claim 1 containing up to 10 wt % onium salt in the layer.

18. The film of claim 1 containing less than 2 wt. % onium salt in the layer.

19. A liquid crystal display comprising the film of claim 1.

20. A process for forming an alignment layer having a predetermined tilt comprising adding a predetermined amount of an onium salt to a coating solution, coating a substrate with the coating solution, and drying the coating.
